(19) United States
(12) Patent Application Publication
(10) Pub. No.: US 2005/0134838 A1
(43) Pub. Date: Jun. 23, 2005

(54) Method and apparatus for checking a thread of a fastener with respect to damages

(75) Inventors: Gunther Hartmann, Alsfeld (DE); Wolfgang Deeg, Homberg/Ohm (DE); Jurgen Hohl, Kirchhain (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignees: Gunther Hartmann; Wolfgang Deeg; Jurgen Hohl

(21) Appl. No.: 11/018,835

(22) Filed: Dec. 20, 2004

(30) Foreign Application Priority Data
Dec. 19, 2003 (DE) 103 59 837.5

(51) Int. Cl. G01N 21/88

(52) U.S. Cl. 356/237.1

(57) ABSTRACT

A thread (2) of a fastener (3) such as a screw, a bolt or a nut is checked with respect to damages. Light beams are directed onto the thread (2) in a way that the light beams are directed substantially perpendicular with respect to a flank (17) of the thread (2). Then, the light beams being reflected by the flank (17) of the thread (2) are collected in a direction substantially perpendicular to the flank (17) of the thread (2) with at least one collecting optical system (18). The collecting optical system (18) has an optical axis (12) which is directed substantially perpendicular with respect to the flank (17) of the thread (2). In this way, it is possible.to reliably differentiate damaged surfaces of the thread (2) of the fastener (3) from undamaged surfaces at great inspecting velocities.

### CROSS REFERENCE TO RELATED APPLICATIONS

This application claims priority to co-pending German Patent Application No. 103 59 837.5 entitled “Verfahren und Vorrichtung zum Überprüfen eines Gewindes eines Verbindungs-elements auf Beschädigungen“, filed Dec. 19, 2003.

### FIELD OF THE INVENTION

The present invention generally relates to a method and an apparatus for checking a thread of a fastener with respect to damages. Preferably, the fastener is designed as a screw, a bolt or a nut.

### BACKGROUND OF THE INVENTION

A method and an apparatus for checking a thread of a fastener with respect to damages are known from German Patent Application No. DE 101 40 374 A1. The known apparatus includes a matrix camera, an objective lens, a beam guiding optical system, an image evaluating unit and a monitor. The fastener to be checked is completely and uniformly illuminated by an annular lamp. The optical axis of the matrix camera, the objective lens and the annular lamp are identical to the center axis of the fastener. This means that the thread being located at the shank of the fastener is illuminated in a diffuse way in the axial direction. As a result, light is reflected into the camera by undamaged portions as well as by damaged portions of the thread. Thus, the undamaged portions and damaged portions being imaged into the matrix camera by the beam guiding optical system only show insignificant differences concerning brightness and contrast. There is the drawback that undamaged portions and damaged portions of the thread are difficult to be differentiated during evaluation of the camera images. Thus, reliability of the known checking method is negatively influenced. Another drawback of the known method is the fact that the axial end portion of the fastener facing the camera is always contained in the image of the camera to be evaluated. This end portion of the fastener does not fulfill a substantial function of the fastener. As a result, less surface for the surface area of the fastener to be represented is available in the camera. Due to the limited resolution of the camera, this has a negative effect on the resolution.

In addition, when centrically arranging the matrix camera, the objective lens and the annular lamp, it is necessary to position the fastener to be checked in an exact way with respect to the matrix camera, the objective lens and the annular lamp to ensure that one attains the desired circular shape in the image instead of an elliptical shape.

### SUMMARY OF THE INVENTION

The present invention relates to a method of checking a thread of a fastener with respect to damages. Light beams are directed onto the thread in a way that the light beams are directed substantially perpendicular with respect to a flank of the thread. Then, the light beams being reflected by the flank of the thread are collected in a direction substantially perpendicular to the flank of the thread with at least one collecting optical system. The collecting optical system has an optical axis which is directed substantially perpendicular with respect to the flank of the thread.

The present invention also relates to an apparatus for checking a thread of a fastener with respect to damages. The apparatus includes at least one lighting unit. The lighting unit is designed and arranged to illuminate the fastener to be checked. The lighting unit is oriented with respect to the fastener such that light beams radiated by the lighting unit are directed substantially perpendicular with respect to a flank of the thread of the fastener. At least one collecting optical system is designed and arranged to collect the light beams reflected by the flank of the thread of the fastener. The collecting optical system has an optical axis which is oriented to be substantially perpendicular with respect to the flank of the thread of the fastener. The collecting optical system is oriented with respect to the fastener to substantially collect the light beams which are reflected in a perpendicular direction with respect to the flank of the thread of the fastener.

With the novel method and apparatus for checking a thread of a fastener with respect to damages, it is possible to reliably differentiate damaged surfaces from undamaged surfaces at great inspecting velocities. Such great inspecting velocities are especially such ones of more than approximately 300 fasteners per minute. Such great inspecting velocities are possible since the fasteners to be checked by the novel method and apparatus do not have to be rotated for inspection purposes. Depending on the result of the inspection, the fastener is classified as an acceptable part or an unacceptable part to be associated with the respective material flow.

The present invention is based on the concept of directing the light beams serving to illuminate the thread of the fastener substantially perpendicular with respect to a flank of the thread, and to collect the reflected light beams in the same substantially perpendicular direction. Due to the fact that damages of the thread of a fastener mostly occur in the region of the flank of the thread, the flank is the relevant portion to be checked. Since it is known that light beams are reflected by objects according to the principle “incident angle=angle of reflection”, an undamaged flank of the thread reflects light beams (which are directed substantially perpendicular with respect to the flank) into the collecting optical system which is also oriented in this substantially perpendicular direction according to the invention. Consequently, the undamaged portion of the flank of the thread has a greater brightness value in the recorded image. In case the flank is damaged at this place, this means that the damaged surface is located at a different angle than the undamaged flank. Thus, only small portions of the light being reflected by such a damaged surface reach the collecting optical system. Consequently, the part of the image representing the damaged surface has a lower brightness value. In other words, the damaged surface is easily detectable in the image as a dark portion.

Preferably, the collected reflected light beams are recorded by at least one camera. Preferably, the at least one camera is connected to at least one evaluating unit with which the at least one recorded image is evaluated to derive a classification of the fasteners based on predetermined criteria. Preferably, only one evaluating unit is used. However, especially when using a plurality of cameras, it may be advantageous to use a plurality of evaluating units. In the end, one single total evaluation of the check results is realized. For this purpose, the evaluating unit produces and transmits a go/no-go signal after processing of the reflected light beams. For example, this signal is used for control of an ejector serving to eject damaged fasteners from the flow of material. The novel method and apparatus do not require the use of a separate beam guiding optical system for redirecting the reflected light beams into the camera since the camera is already located in the desired place and orientation with respect to the reflected light beams. Correspondingly, there are no distortions as they are produced by light guiding optical systems used in the prior art. The distance between the fasteners and the cameras may be chosen to be greater than in the prior art. Such an arrangement simplifies assembly and operation of the apparatus. For example, the distance may be approximately at least 10 cm, preferably approximately 20 cm or more.

Preferably, the apparatus is arranged in an automatic machine which supplies the fasteners to be checked separately and which positions the fasteners with respect to the collecting optical systems in a suitable way. When the respective fastener has been correctly positioned, a signal indicative of this fact is transmitted to the evaluating unit. The checking operation then begins. After completion- of the checking operation, the inspected fastener is transported away. In the following, depending on the signal produced by the evaluating unit, the fastener is either classified as an accepted fastener or an unaccepted fastener. The fasteners of these two categories are then separated. When the evaluating unit operates at appropriate great processing velocities, the entire method may be conducted in a continuous way. This means that it is not necessary to stop the fastener to be checked in front of the collecting optical system. In this way, it is possible to realize great checking rates with the novel method and apparatus.

It is to be understood that the novel apparatus may be used in combination with additional novel apparatuses or also prior art apparatuses arranged in an automatic machine. For example, the novel apparatus may be combined with a known apparatus for measuring the dimensions of the fastener.

Preferably, each collecting optical system only observes a fraction of the surface area of the fastener and of the threaded portion of the fastener, respectively. It is not necessary to observe the end portion of the shank facing away from the head of the fastener since damages occurring at this place do not limit functionality of the fastener. Preferably, a plurality of collecting optical systems and cameras are used. It is preferred to arrange these collecting optical systems and cameras such that adjacent optical systems and cameras observe a partly overlapping part of the surface area of the fastener. In this way, the entire portion of the fastener to be checked is observed. Depending on the design and size of the collecting optical system, two, three, preferably four or more collecting optical systems and cameras may be used. Since the fastener preferably is located in the middle between the collecting optical systems for checking purposes, the number of four collecting optical systems provides the advantage that the fastener may be transported towards and away from the place of checking by passing between two collecting optical systems. Such an arrangement is especially preferred if the part of the surface area of the fastener to be checked is not located at one axial end of the fastener.

Partial recording of the surface area by separate optical systems and cameras improves resolution and reduces distortions of the entire image. It has to be taken into account that there always are certain variations when positioning the fastener. In addition, it is possible to change the inclination of the beam path with respect to the axis of the fastener in a comparatively easy way.

It is preferred to direct the light beams substantially perpendicular with respect to a flank of the thread in the region of the center axis (middle axis) of the fastener. In this way, it is realized that the deviation from the ideal angle of 90° towards both radial directions from the center axis of the fastener is kept as low as possible. It has been found that angles in a region of approximately 70° to approximately 110° with respect to the flank of the thread in the region of the center axis of the fastener lead to good reflection results. At least such angles are to be understood to be included in the definition of “substantially perpendicular” as used herein. Furthermore, it is preferred to direct the light beams substantially perpendicular to such a flank of the thread of the fastener which is located in the region of the middle of the region to be checked as seen in an axial direction of the fastener.

The present invention relates to the check (or inspection) and analysis of a fastener concerning damages. It is to be understood that the present invention may not only be applied to check threads, but also other profiles similar to threads such as helical profiles or groove profiles. In such cases, the light beams are directed and collected approximately perpendicular to the part of the thread-like profile which corresponds to the flank of a thread. In case of a helical profile, this part is the helix, meaning the radially protruding portions of the helical profile. It is emphasized that the term “thread” used in the claims and this description is to be interpreted in a broader way compared to the general definition. The same applies to the term “flank”. It is to be understood that this term according to the definition of this application also includes the helix of a helical profile or the protrusion of a groove profile.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a side view of a first exemplary embodiment of the novel apparatus.

FIG. 2 is a three-dimensional side view of the first exemplary embodiment of the novel apparatus.

FIG. 3 is a side view of a second exemplary embodiment of the novel apparatus.

FIG. 4 is a three-dimensional side view of the second exemplary embodiment of the novel apparatus.

FIG. 5 is a top view of the second exemplary embodiment of the novel apparatus.

FIG. 6 is a side view of a third exemplary embodiment of the novel apparatus.

FIG. 7 is a three-dimensional side view of the third exemplary embodiment of the novel apparatus.

FIG. 8 is a top view of the third exemplary embodiment of the novel apparatus.

FIG. 9 is a side view of a fourth exemplary embodiment of the novel apparatus.

FIG. 10 is a three-dimensional side view of the fourth exemplary embodiment of the novel apparatus.

### DETAILED DESCRIPTION

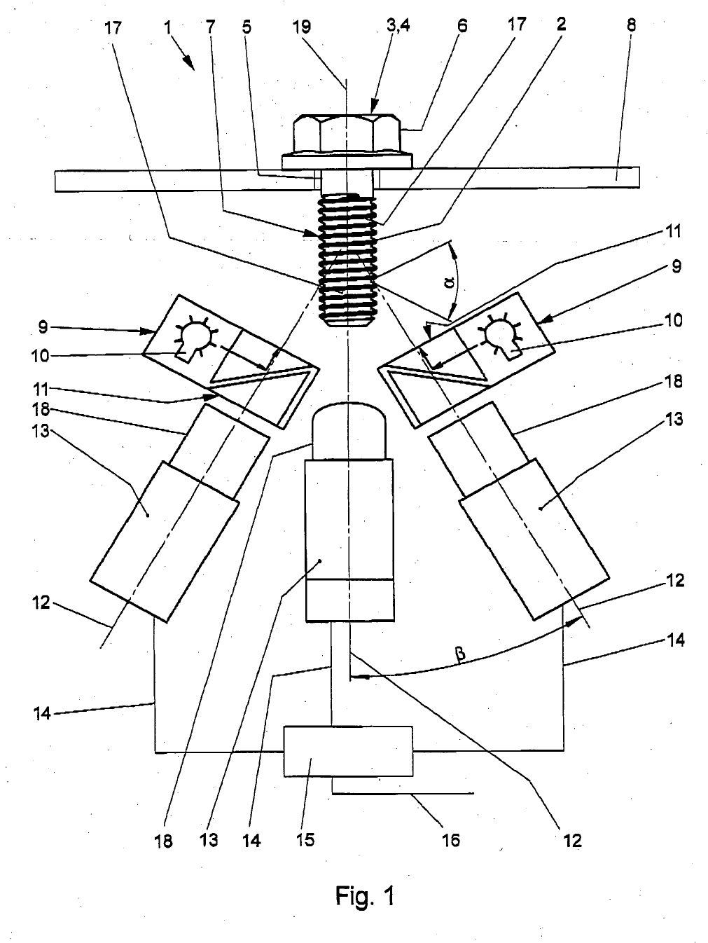

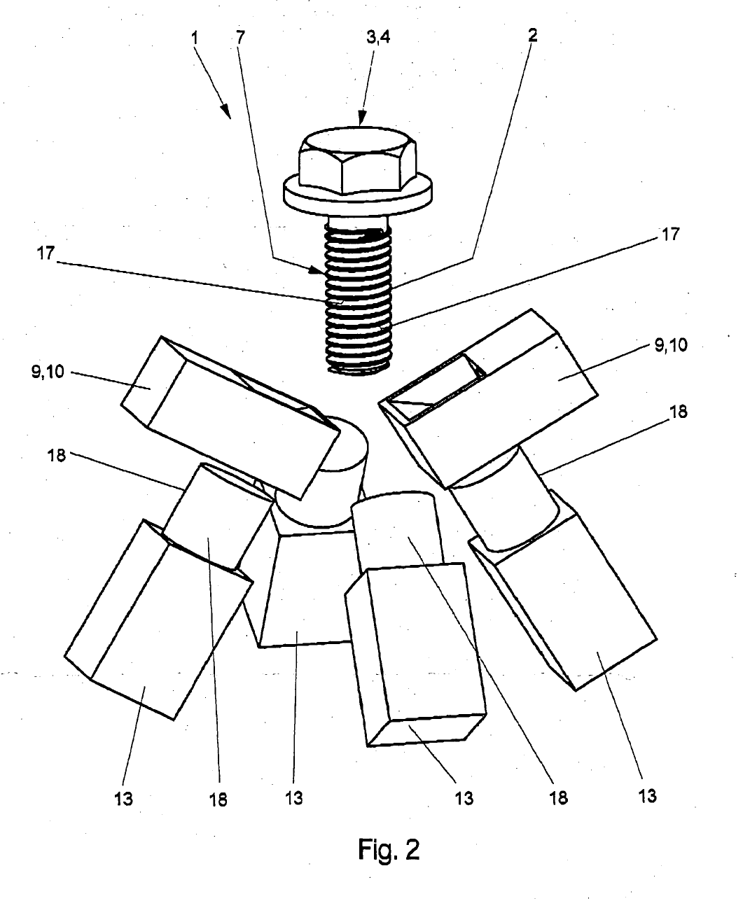

Referring now in greater detail to the drawings, FIG. 1 and 2 illustrate a first exemplary embodiment of the novel apparatus 1 for checking a thread 2 of a fastener 3 with respect to damages. In the illustrated exemplary embodiment, the fastener 3 is designed as a screw 4. The screw 4 includes a shank 5, a head 6 being located at one end of the shank 5 and a threaded portion 7 including a thread 2 located in the region of the other end of the shank 5. The fastener 3 is located in a transporting apparatus 8. The transporting apparatus 8 may be designed as a rotary table and the like. Such a transporting apparatus is generally known in the art, and it thus will not be described herein in greater detail.

The apparatus 1 includes a plurality of lighting units 9 for lighting or illuminating the fastener 3 to be checked. In the illustrated case, each of the lighting units 9 includes a lighting apparatus 10 and a semitransparent mirror 11. A camera 13 is arranged symmetrically with respect to the optical axis 12 of the lighting unit 9 and in a direction away from the fastener 3. The camera 13 is connected to an evaluating unit 15. The evaluating unit 15 is connected to a line 16 by which a go/no-go signal is transmitted, as this will be explained below in greater detail.

Referring to FIG. 1—and especially when considering the three-dimensional arrangement of the apparatus 1 according to FIG. 2—it is to be clearly seen that the lighting unit 9 as well as the cameras 13 are arranged at a certain angle with respect to a flank 17 of the thread 2 of the screw 4. The relevant arrangement is the one of the collecting optical system 18 of the cameras 13. It is to be understood that the arrangement of the housing of the cameras 13, for example, is of minor importance.

The optical axis 12 of the lighting unit 9 is oriented with respect to a flank 17 of the thread 2 of the fastener 3 such that the light beams are directed (or radiated, transmitted) substantially perpendicular with respect to the flank 17 of the thread 2. In the illustrated exemplary embodiment, this is realized by the semitransparent mirror 11 which reflects the light beams produced and sent out by the lighting apparatus 10 in the direction of the optical axis 12 and thus approximately perpendicular to the flank 17 of the thread 2. Due to its semitransparent properties, the semitransparent mirror 11 allows for the light beams being directed approximately perpendicular with respect to the flank 17 and which are reflected by the flank 17 in the same direction to reach the region of the collecting optical system 18 and the camera 13. Due to this relative arrangement, it is possible to effectively determine damages of the flank 17 of the thread 2 of the fastener 3. In case there is such damage, most of the light beams being reflected by the damaged surface are not reflected into the region of the collecting optical system 18. Consequently, such damaged portions are perceptible as black surfaces on the image produced by the camera 13. Intact flanks 17 reflect the light beams through the semitransparent mirror 11 into the collecting optical system 18 and the corresponding CCD chip, for example, of the camera 13 such that such intact portions have a comparatively great brightness value and they are perceptible as bright surfaces in the image.

In case the fastener 3 is designed as a screw 4 including a metric thread 2 having a flank angle of 60° (angle a in FIG. 1), the optimal radiation angle is 30° (angle β in FIG. 1) with respect to the center axis of the fastener 3.

The lighting unit 9, the collecting optical system 18 and the cameras 13 are spatially arranged (see FIG. 2) such that the entire region of the thread 2 may be checked with respect to damages. Each one of the above described units covers a part of the thread 2. For a complete check of the thread 2, the parts preferably overlap. The separate images taken of the parts are transmitted to the evaluating unit 15 by the lines 14. The evaluating unit 15 determines a value indicative of the go/no-go-properties of the fasteners 3. The determination is based on certain algorithms and on the brightness value and the contrast, respectively, of the images. The signal corresponding to this determination is transmitted by a line 16, and it is further processed in a suitable way such that accepted fasteners 3 may be separated from non-accepted fasteners 3.

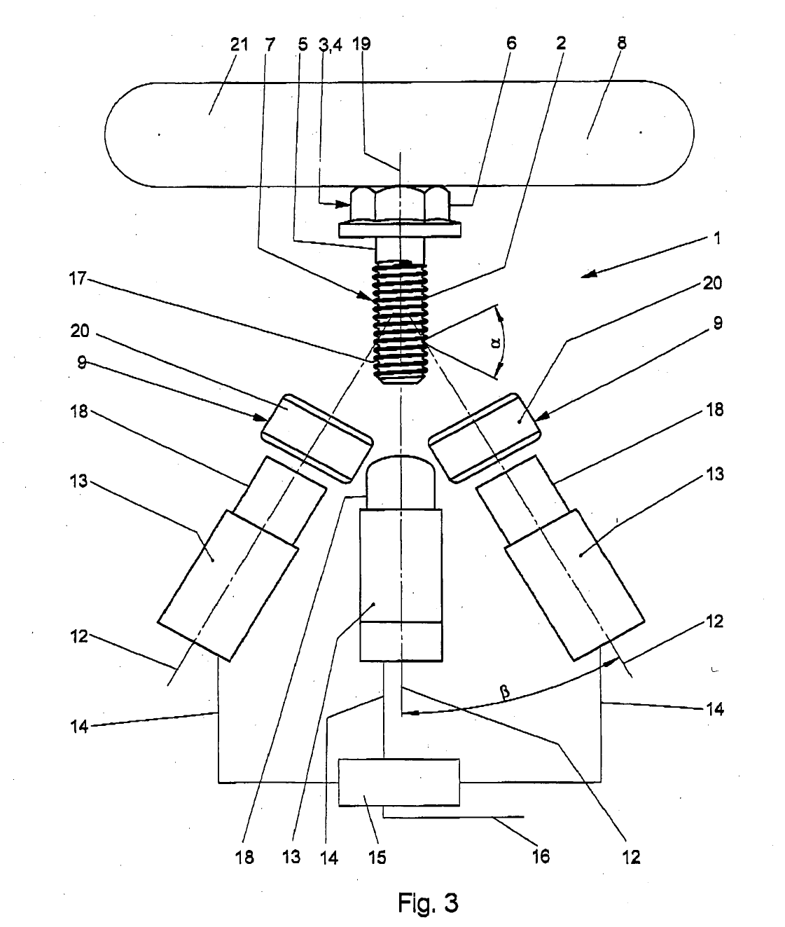

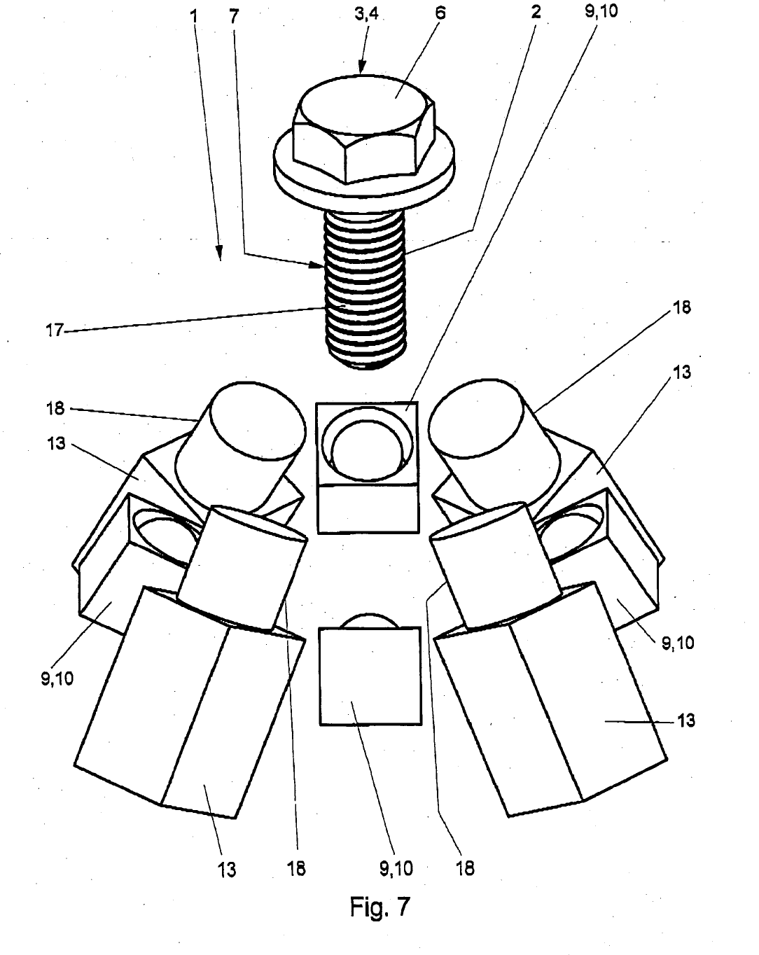

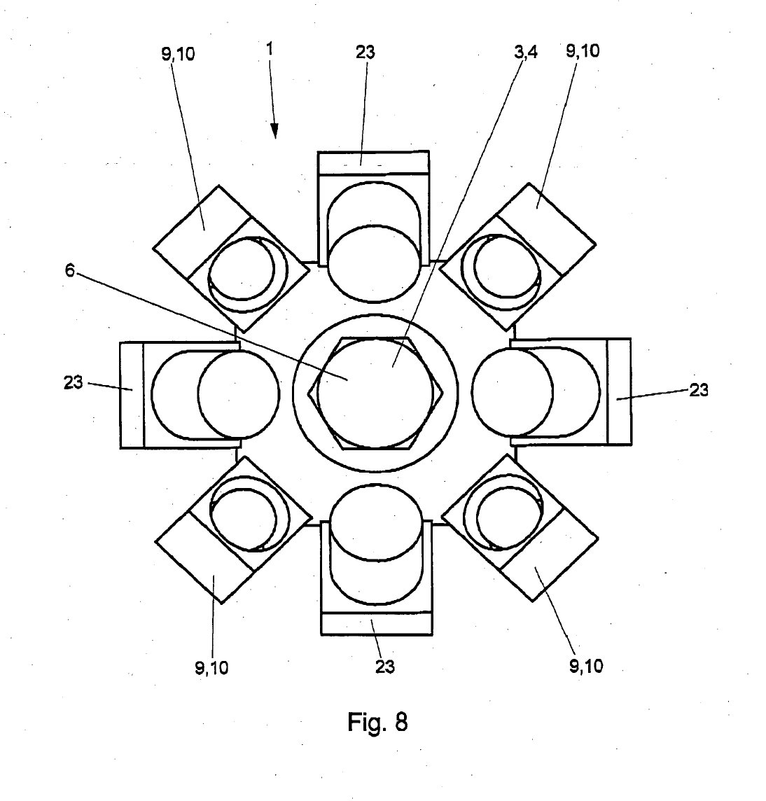

It is to be realized that the illustration of FIG. 1 is chosen such that the two cameras 13 being arranged in the region of the center axis 19 of the fastener 3 overlap in this illustration. In other words, only the foremost camera 13 of these two cameras 13 is to be seen in the illustration of FIG. 1. In addition, for reasons of clarity, the lighting units 9 of the cameras 13 are not illustrated. It is to be understood that these two cameras 13 also include the lighting units 9 the same way as the other cameras 13 illustrated in FIG. 1. The same applies to FIGS. 3-10.

FIG. 3 is an illustration similar to the one of FIG. 1. Instead of the semitransparent mirror, the lighting unit 9 of this exemplary embodiment includes an annular lighting apparatus 20. The lighting apparatus 20 also radiates the light beams mostly in the direction of the optical axis 12 and approximately perpendicular to the flank 17 of the thread 2 of the fastener 3. Furthermore, a different transporting apparatus 8 is illustrated as an example. In this case, the transporting apparatus 8 is designed as a magnetic tape. However, it is to be understood that it is also possible to use different transporting apparatuses 8.

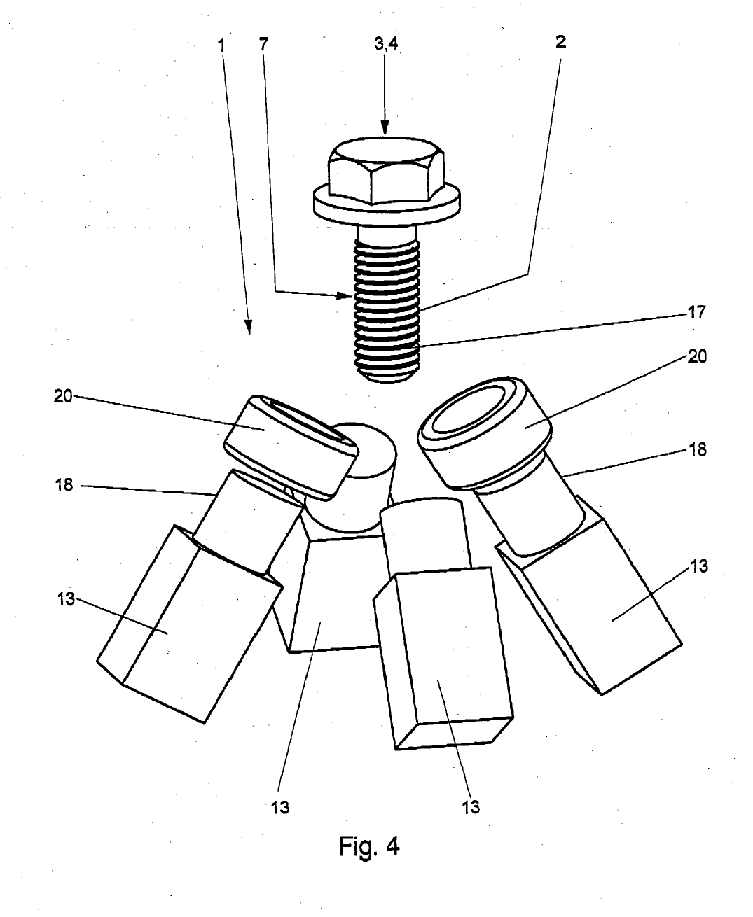

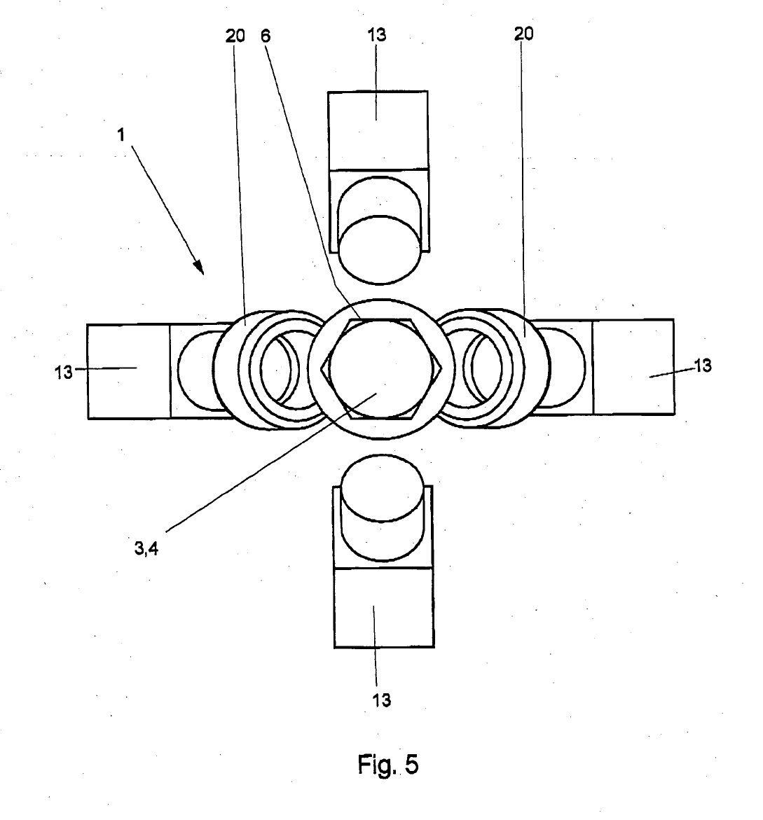

More details are illustrated in FIGS. 4, 5.

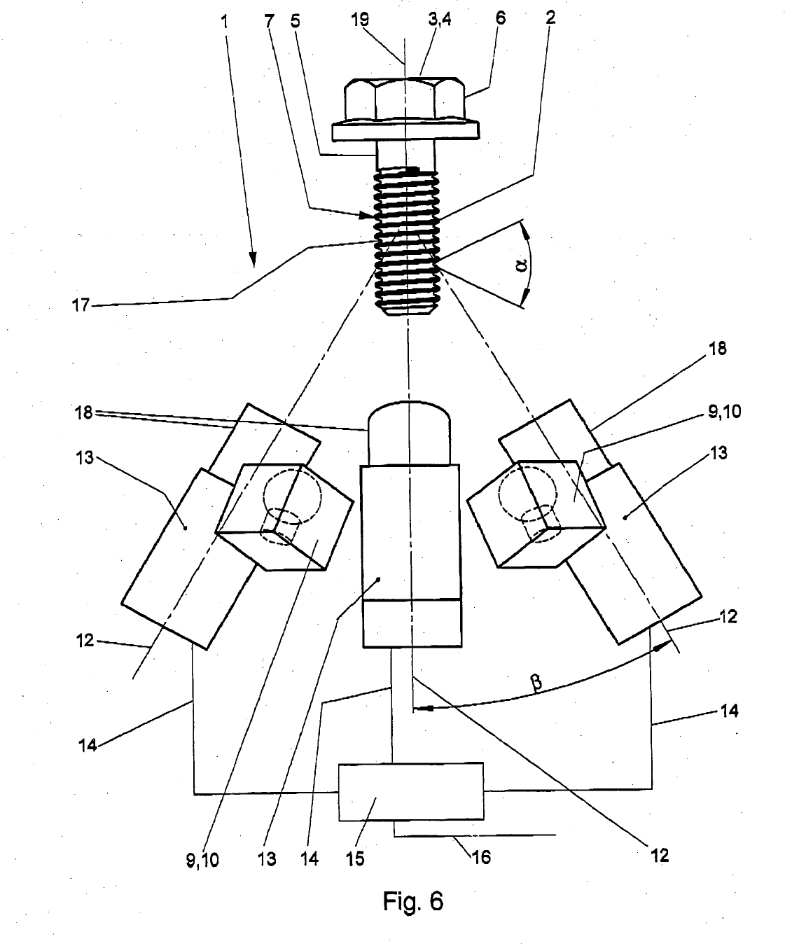

FIGS. 6-8 illustrate another exemplary embodiment of the apparatus 1 for conducting the novel method for checking a thread 2 of a fastener 3 with respect to damages. In this case, the lighting units 9 are designed as separate screened lighting apparatuses 10 which also radiate light beams substantially perpendicular to the flank 17 of the thread 2 of the screw 4. One advantage of this arrangement is the possibility of using comparatively simple and inexpensive lighting units 9.

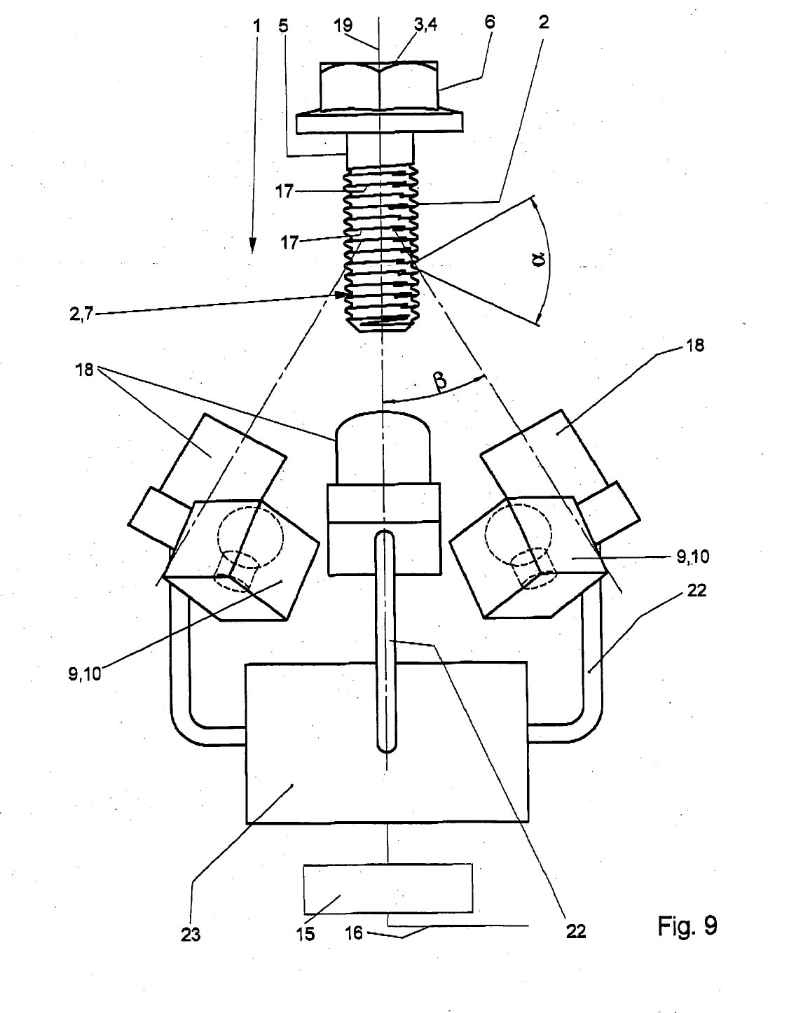

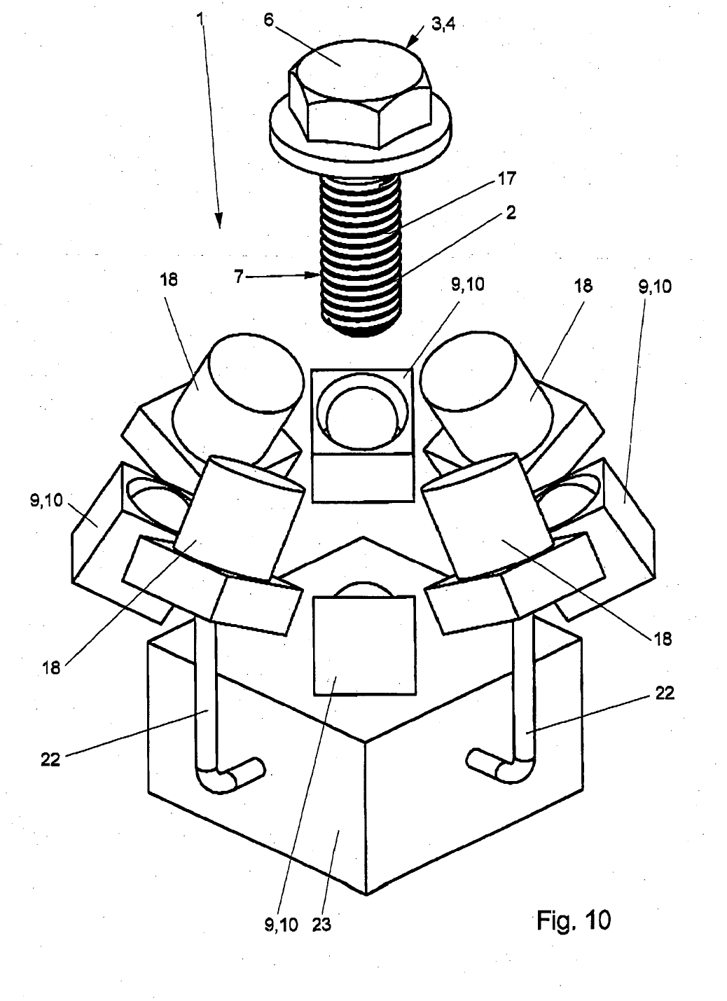

FIGS. 9, 10 illustrate another exemplary embodiment of the novel apparatus 1. In this case, the collecting optical systems 18 are not designed as integral portions of a camera, but they are instead connected to one separate camera 23 by transmitting optical systems 22. This arrangement has the advantage that it is possible to arrange the comparatively small collecting optical systems 18 adjacent to the fastener 3, while the comparatively big camera 23 may be arranged further away from the region in which there may be undesired contact with the fasteners 3.

Many variations and modifications may be made to the preferred embodiments of the invention without departing substantially from the spirit and principles of the invention. All such modifications and variations are intended to be included herein within the scope of the present invention, as defined by the following claims.

### PREFERRED CONCRETE EMBODIMENT

The following components of the novel apparatus have been found to be especially suitable for realizing the invention:

| | |
|---|---|
| lighting unit and | diffuse bright field illumination with mirror |
| lighting apparatus | F150 RV = DOAL50 W by Omron; or |
| | lamp 11 W 0.0.417.06 by item; or |
| | annular lighting apparatus type A08630 |
| | including VLP Intralux DC-1100 by Otto |
| collecting optical system | Pentax 16 mm; 1:1,4 |
| camera | Pulnix TM 6702 by Otto; or |
| | F150-S1A by Omron |
| evaluating unit | CVS300 by Otto; or |
| | F150-C15E-3 by Omron |
| transporting apparatus | permanent magnet screw conveyor accord- |
| | ing to drawing 390.0368.0000.0000 by NSM |

1. A method of checking a thread of a fastener with respect to damages, said method comprising the steps of:
directing light beams onto the thread in a way that the light beams are directed substantially perpendicular with respect to a flank of the thread; and
collecting the light beams being reflected by the flank of the thread in a direction substantially perpendicular to the flank of the thread with at least one collecting optical system, the collecting optical system having an optical axis, the optical axis being directed substantially perpendicular with respect to the flank of the thread.

2. The method of claim 1, wherein the fastener includes a center axis and the light beams are directed onto the thread substantially perpendicular with respect to a flank of the thread in the region of the center axis of the fastener.

3. The method of claim 1, wherein the fastener includes a center axis and the light beams are directed onto the thread at an angle of approximately 90° with respect to a flank of the thread in the region of the center axis of the fastener.

4. The method of claim 2, wherein the fastener includes a center axis and the light beams are directed onto the thread at an angle of approximately 90° with respect to a flank of the thread in the region of the center axis if the fastener.

5. The method of claim 1, wherein the collected reflected light beams are recorded by at least one camera.

6. The method of claim 5, wherein the camera has an optical axis, the optical axis being arranged approximately perpendicular with respect to a flank of the thread.

7. The method of claim 1, wherein the collected reflected light beams are recorded by a plurality of cameras, each of the cameras recording a part of the fastener, the parts being chosen to overlap.

8. The method of claim 2, wherein the collected reflected light beams are recorded by a plurality of cameras, each of the cameras recording a part of the fastener, the parts being chosen to overlap.

9. The method of claim 3, wherein the collected reflected light beams are recorded by a plurality of cameras, each of the cameras recording a part of the fastener, the parts being chosen to overlap.

10. The method of claim 4, wherein the collected reflected light beams are recorded by a plurality of cameras, each of the cameras recording a part of the fastener, the parts being chosen to overlap.

11. The method of claim 1, wherein damaged regions of the fastener are determined based on analysis of their brightness value, the brightness value being less than a brightness value of undamaged regions of the fastener.

12. The method of claim 11, wherein only the thread of the fastener is analyzed.

13. An apparatus for checking a thread of a fastener with respect to damages, comprising:
at least one lighting unit, said lighting unit being designed and arranged to illuminate the fastener to be checked, said lighting unit being oriented with respect to the fastener such that light beams radiated by said lighting unit are directed substantially perpendicular with respect to a flank of the thread of the fastener; and
at least one collecting optical system, said collecting optical system being designed and arranged to collect the light beams reflected by the flank of the thread of the fastener, said collecting optical system having an optical axis, the optical axis being oriented to be substantially perpendicular with respect to the flank of the thread of the fastener, said collecting optical system being oriented with respect to the fastener to substantially collect the light beams which are reflected in a perpendicular direction with respect to the flank of the thread of the fastener.

14. The apparatus of claim 13, wherein said lighting unit includes a semitransparent mirror, said semitransparent mirror including a lighting apparatus.

15. The apparatus of claim 13, wherein the lighting unit includes an annular lighting apparatus.

16. The apparatus of claim 13, comprising a plurality of lighting units and collecting optical systems, said lighting units and collecting optical systems each being designed and arranged to observe a part of the fastener, the parts being chosen to overlap.

17. The apparatus of claim 14, comprising a plurality of lighting units and collecting optical systems, said lighting units and collecting optical systems each being designed and arranged to observe a part of the fastener, the parts being chosen to overlap.

18. The apparatus of claim 15, comprising a plurality of lighting units and collecting optical systems, said lighting units and collecting optical systems each being designed and arranged to observe a part of the fastener, the parts being chosen to overlap.

19. The apparatus of claim 13, further comprising at least one camera, said camera being associated with said at least one collecting optical system.

20. The apparatus of claim 13, further comprising one camera, said one camera being associated with said at least one collecting optical system.

21. The apparatus of claim 13, comprising a plurality of collecting optical systems and a plurality of cameras, each one of said cameras being associated with one of said collecting optical systems.

22. The apparatus of claim 13, further comprising at least one evaluating unit, said evaluating unit being designed and arranged to detect damaged portions of the thread of the fastener based on a comparison of a brightness value of an undamaged portion of the thread of the fastener with a brightness value of a damaged portion of the thread of the fastener.
